(19) United States
(12) Patent Application Publication
(10) Pub. No.: US 2021/0316919 A1
(43) Pub. Date: Oct. 14, 2021

(54) RECYCLABLE SACHETS

(71) Applicant: The Procter & Gamble Company, Cincinnati, OH (US)

(72) Inventors: Martin Ian James, Hamilton, OH (US); Gary Wayne Gilbertson, Liberty Township, OH (US); John Moncrief Layman, Liberty Township, OH (US); Susan Nicole Lloyd, Erlanger, KY (US); Emily Charlotte Boswell, Cincinnati, OH (US); Patti Jean Kellett, Cincinnati, OH (US); Stefano Bartolucci, Singapore (SG)

(21) Appl. No.: 17/182,265

(22) Filed: Feb. 23, 2021

Related U.S. Application Data
(60) Provisional application No. 63/008,864, filed on Apr. 13, 2020.

(51) Int. Cl. B65D 65/40; A45D 40/00; B32B 27/36; B32B 27/20; B32B 15/09; B32B 15/20; B65D 65/42; A45D 33/00

(52) U.S. Cl. CPC B65D 65/40; A45D 40/0087; B32B 27/36; B32B 27/20; B32B 15/09; B32B 15/20; B32B 2439/46; A45D 33/005; B32B 2255/26; B32B 2255/06; B32B 2307/7246; B32B 2307/7163; B65D 65/42

(57) ABSTRACT

Sachets composed of metal barrier layers that can include both a sealant and an external protective coating material. The sealant provides heat sealing, and product formulation protection properties, while the barrier material functions to reduce the moisture vapor transmission rate (MVTR) into or out of the sachet.

### FIELD OF THE INVENTION

The invention relates to environmentally benign recyclable sachets (i.e., small bags) useful for enclosing a consumer product, such as, for example, shampoo, conditioner, skin lotion, shave lotion, liquid soap, bar soap, toothpaste, and detergent.

### BACKGROUND OF THE INVENTION

Polymers, such as polyethylene, have long been used as sachets (i e, small bags) for the packaging of products that have a short use cycle (e. g., less than about 12 months). Sachets are generally composed of multiple layers that include different types of materials to provide desired functionality, such as sealing, barrier, and printing. In food packaging, for example, a sachet is often used as a protective agent to package food and is quickly disposed of after the contents are consumed. Sachets are also used to house a variety of consumer products that have a short use cycle, such as products for hair care, beauty care, oral care, health care, personal cleansing, and household cleansing. These sachets often enclose just enough product for a single use and are often discarded as litter after that single use. In developed parts of the world, the discarded sachets typically end up in a solid waste stream, which is incinerated or placed in landfills. In regions without modern solid waste infrastructure, used sachets are commonly discarded as litter on the soil and in surface waters. While some efforts at recycling the sachets have been made, the nature of the different polymers that compose the layers of the sachets, the presence of metals, the way the sachets are produced, and the way they are converted to products limit the number of possible recycling applications. For example, repeated processing of even pure polymers results in material degradation and, consequently, poor mechanical properties. In addition, the different grades of chemically similar plastics that are mixed during the recycling process can cause processing problems that make the reclaimed material inferior or unusable. Some plastics manufacturers have introduced additives, such as oxo-biodegradable additives and organic materials, into traditional polymers (e.g., polyethylene, polypropylene, polystyrene, polyvinyl chloride) to promote biodegradation of the polymers in both aerobic environments (e.g., composting, soil) and anaerobic environments (e.g., landfills, sewage systems). Oxo-biodegradable additives are often compounded into a polymer in a concentration of about 1 Wt. % to about 5 Wt. %, based on the total weight of the polymer, and consist of transition metals that theoretically foster oxidation and chain scission in plastics When exposed to heat, air, light, or a mixture thereof. The shortened polymer chains theoretically can be consumed by microorganisms found in the disposal environment and used as a food source. However, the fragmentation is not a sign of biodegradation, and there is no data to show how long these plastic fragments will persist in the soil or marine environments. Further, data have shown that moisture will retard the fragmentation process for months or longer. From a practical perspective, a plastic bag that is littered in the desert will probably fragment in a few months, but the fragments will persist for years or longer. If the same bag is littered in a cold, dark wet forest, it is unlikely that the bag will even fragment for months or years. When organic materials which include, cellulose, starch, ethylene vinyl acetate, and polyvinyl alcohol, are used as additives in traditional plastics, some portion of the additive itself will biodegrade and generate carbon dioxide and methane. No data demonstrate that the remaining 95 Wt. % to 99 Wt. % of the traditional plastic will also biodegrade. The Biodegradable Products Institute (BPI) recommends that a supplier demonstrate that 90% of the entire plastic film or package, not just the additive, be converted to carbon dioxide under aerobic conditions, and carbon dioxide and methane under anaerobic conditions. Sachets composed of biodegradable polymers would seem to provide a solution to the problems described above and are more efficacious and practical than any other articles or materials.

The attributes that render a polymer biodegradable, however, also may prevent it from being used for its intended purpose. Often, biodegradable polymers are moisture sensitive (i.e., can absorb significant amounts of water, swell, lose strength or thickness, or dissolve when exposed to aqueous media), thermally sensitive (i.e., have a melting point or glass transition temperature below about 65 C, or a Vicat softening point of less than about 45 C), mechanically limited (i.e., a product formed from the polymer is too stiff, too soft, suffers from poor tensile strength or tear strength, or has insufficient elongation properties), and/or are difficult to process by conventional melt processes (e. g., cast film extrusion, blown film extrusion) into films. Properties such as tensile strength, tensile modulus, tear strength, and thermal softening point determine to a large extent how well a film will run on converting lines. Biodegradable, metallized cellulose films (e.g., NatureFlex™ by Innovia LLC) have been used to form 12″×2″ sachets that are capable of containing dry products in dry environments. However, these sachets have limited success when filled with liquid consumer products. For example, when these sachets were filled with water and allowed to sit overnight, visible cracking of the metallized film was observed, and the sachets failed within 24 hours, as evidenced by droplets visibly seeping through the film. Degradable sachets suitable for containing a single serving of dry products, such as sugar, are also known. These sachets are composed of paper that is extrusion coated with a grade of MATER-BI™ thermoplastic starch film manufactured by Novamont.

Films composed of a biodegradable polymer layer are described in US. Patent Application Publication No. 2009/0286090, incorporated herein by reference. However, these films require high barrier properties to achieve their desired performance characteristics. To realize these high barrier properties, it is necessary to incorporate non-degradable materials (e.g., polyvinylidene chloride; polyvinyl alcohol; polyvinyl acetate; polyolefins, such as polyethylene and polypropylene; polyamides; extrudable grade ethylene vinyl acetate; extrudable grade ethylene acrylic acid; ethylene vinyl alcohol copolymers (EVOHs) and combinations thereof, such as polyamide/EVOH/polyamide coextrusion) into the biodegradable polymer layer. Thus, these films are only partially biodegradable. A fully degradable film that is a multilayer laminate is described in US. Patent Application Publication No. 2008/0038560, incorporated herein by reference. However, laminates are themselves undesirable because the lamination process is costly. Japanese Patent Application 2005/111783, incorporated herein by reference, discloses packages with a resin composition of polylactic acid and lactic acid group co-polyesters upon which aluminum was vapor deposited. However, these films only degrade under industrial composting conditions and do not biodegrade in an open environment.

Polyhydroxyalkanoates (PHAs) also have been of general interest for use in forming biodegradable films. For example, U.S. Pat. No. 5,498,692, incorporated herein by reference, discloses a biodegradable film composed of a polyhydroxyalkanoate copolymer that has at least two randomly repeating monomer units. This film can be used to form, for example, grocery bags, food storage bags, sandwich bags, resealable Ziploc®-type bags, and garbage bags. PHA films or other biodegradable films may also be used to create a sachet, although a sachet comprising only PHA will not meet the barrier requirements for most consumer goods. Although PHAs are biodegradable, their actual use as a plastic material has been hampered by their thermal instability. PHAs tend to have low melt strengths and may also suffer from a long set time, such that they tend to be difficult to melt process. Further, PHAs tend to undergo thermal degradation at very high temperatures (i.e., the temperatures that can be encountered during melt processing). Further still, PHAs have poor gas and moisture barrier properties, and are not well suited for use as packaging materials, as described in US. Patent Application Publication No. 2009/0286090, incorporated herein by reference.

None of the single use sachets that are currently in use and composed of a single layer of biodegradable polymers (i.e., no laminate) can withstand the manufacturing process, have a long shelf life, meet barrier requirements, are compatible with current recycling infrastructure, and biodegrade within a relatively short time period in an open environment.

### SUMMARY OF THE INVENTION

In one aspect, the invention relates to a package that includes a biodegradable sealant coated onto a barrier material, upon which ink is deposited (see FIG. 1). Optionally, the ink is coated with a clear biodegradable lacquer or additional clear biodegradable laminated film. The sealant is present in a thickness of about 5 μm to about 100 μm, preferably about 7 μm to about 50 μm, more preferably about 10 μm to about 25 μm. The barrier material is selected from the group consisting of a metal, or metal alloy, consisting primarily of aluminum. The barrier material is present in a thickness of about 7 μm to about 100 μm, preferably about 10 μm to about 50 μm, more preferably about 15 μm to about 30 μm and has a surface energy that is at least about 38 dynes/cm, preferably at least about 42 dynes/cm. Alternatively, the surface has an energy of less than about 38 dynes/cm but can be treated to result in the desired surface energy using techniques known to one skilled in the art, such as corona treatment. The ink is present in a thickness of about 0.5 μm to about 20 μm, preferably about 1 μm to about 10 μm, more preferably about 2.5 μm to about 3.5 μm. The ink may cover up to 100% of the surface of the package but preferably up to 75% and even more preferably up to 50% of the surface of the package. Having un-printed metal visible at the surface will facilitate identification and collection of the packages for recycling. When present, the lacquer or external film has a thickness of up to about 25 μm, preferably up to about 10 μm. The packages and articles of the invention have a shelf life of at least about one year, preferably, at least about two years, more preferably at least about three years. After the packages of the invention are used by, for example, a consumer, they may be discarded into the open environment (i.e., not industrial compositing conditions), where they are exposed to sealant-degrading microorganisms. After first, and continuous exposure to water and sealant-degrading microorganisms, the polymeric components of these packages disintegrate into pieces sufficiently small to pass through a one millimeter sieve within two years, preferably within about eighteen months, more preferably within about one year. The barrier layer will not biodegrade when exposed to sealant-degrading microorganisms, but will disintegrate into inorganic material upon oxidation after removal of the protective polymeric layers. Preferably the packages of the invention will be collected for recycling, most preferably recycling in the aluminum waste stream from where the metal barrier layer can be recovered and recycled.

The packages of the invention have a MVTR of less than about 10 grams per square meter per day (g/m2/day), preferably less than about 5 g/m2/day, more preferably less than about 2 g/m2/day, even more preferably less than about 1 g/m2/day, still more preferably less than about 0.6 g/m2/day, for example, less than about 0.4 g/m2/day, or less than about 0.2 g/m2/day, at about 37° C. and about 90% relative humidity (RH).

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 depicts the construction of a sachet package that includes a biodegradable sealant coated on an aluminum or aluminum alloy barrier layer, upon which is deposited an external protective layer. The sachet contains a product which may be solid or liquid. Optionally, the sachet includes an ink layer between the aluminum barrier and the external protective layer and optionally a tie layer between the aluminum barrier and the sealant layer.

FIG. 2 depicts a film construction suitable for making a sachet package that includes a biodegradable heat seal layer, an optional tie layer, an aluminum or aluminum alloy barrier layer, an ink layer covering up to 50% of the surface of the barrier layer and an external protective layer.

### DETAILED DESCRIPTION OF THE INVENTION

It is now found that environmentally benign sachets can be produced that are compatible with recycling systems, degradable in ocean water, withstand the manufacturing process, have a long shelf life, and when discarded into the open environment, the polymeric layers will disintegrate within a short time period into pieces small enough to fit through a 1 mm sieve after first and continuous exposure to water and sealant-degrading microorganisms. The sachets of the invention advantageously are easily identifiable as a recyclable material containing mostly aluminum, yet easily degrade when introduced in salt water and do not require industrial composting conditions for degradation. The relatively long shelf life of the sachets of the invention allow them to be stored or transported for a long period of time without a decrease in the physical and chemical integrity of the sachet, even when they contain liquid consumer products. The relatively fast biodegradation of the sachets results in a significant decrease in environmental litter. The films used to produce the sachets of the invention can advantageously be used to form other articles, such as, for example, trash bags, components of diapers, incontinence products, feminine hygiene products, food packaging, tubes, refill packs, and standup pouches. Further, the films used to produce the sachets of the invention are less dependent on petroleum-based feedstocks than the polyolefin films that are traditionally used. Thus, the sachets of the invention may have a reduced carbon footprint when compared to traditional sachets.

The sachets of the invention are composed of metal barrier layers that can include both a sealant and an external protective coating material. The sealant of the invention provides; heat sealing, and product formulation protection properties. The barrier material functions to reduce the moisture vapor transmission rate (MVTR) into or out of the package. The barrier material can also serve to limit diffusion through the package wall of any diffusive species. Nonlimiting examples of diffusive species include O2, CO2, aroma, and perfume. Surprisingly, the specific combination of the sealant and barrier material of the invention functions to provide a suitably long shelf life of the sachet, protect the contents of the sachet from the outside environment, and impart a relatively low moisture vapor transmission rate to the sachet, while also allowing the sachet to undergo disintegration after first, and continuous exposure to water and sealant-degrading microorganisms, in less than two years, preferably less than about eighteen months, more preferably less than about one year. In addition, the sachets can be recycled in the same stream as the primary barrier material of which they are composed.

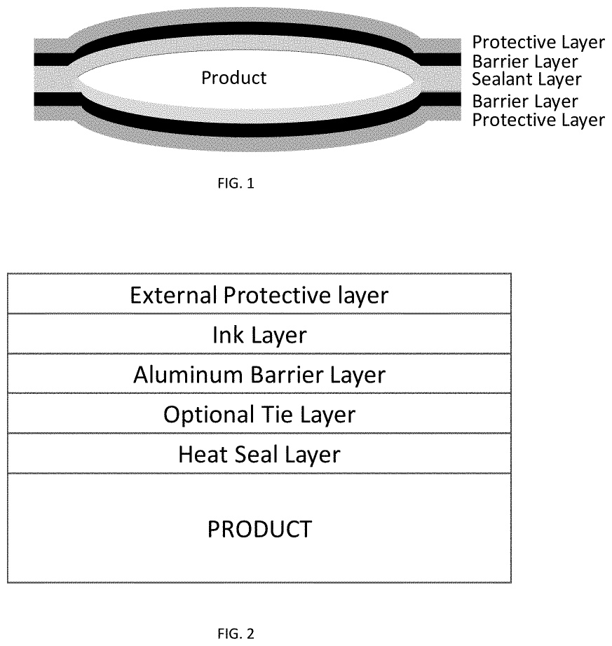

In a first aspect, the invention relates to a package represented by FIG. 1. In this aspect, the package includes a metal or metal alloy barrier layer coated with a biodegradable sealant, upon which ink is deposited. The ink may be biodegradable e.g. as available from Sun Chemicals. Optionally, the ink is coated with a biodegradable lacquer or biodegradable polymer film. The sealant in this aspect of the invention can be any biodegradable polymer. In some embodiments, the sealant is selected from the group consisting of polyhydroxyalkanoate (PHA), polyvinyl alcohol, aliphatic aromatic polyesters (e. g., ECOFLEX® from BASF), thermoplastic starch films (e.g., MATER-BI from Novamont or PLANTIC® films from Plantic), polybutylene succinate and copolymers thereof (e.g., BIONOLLE® from ShoWa High polymer Co.), starch-based film, and mixtures thereof. The PHA can be obtained as copolymers that are commercialized as film grades for extrusion and blowing from ShenZhen Ecomann Biotechnology Co., Danimer Scientific, Inc., which produces poly(beta-hydroxyalkanoate), poly(3-hydroxybutyrate-co-3-hydroxyhexanoate) NODAX™), or Kaneka which produces poly(3-hydroxybutyrate-co-3-hydroxyhexanoate). Non limiting examples of PHA copolymers include those described in U.S. Pat. No. 5,498,692. Other PHA copolymers can by synthesized by methods known to one skilled in the art, such as, from microorganisms, the ring-opening polymerization of beta-lactones, the dehydration-polycondensation of hydroxyalkanoic acid, and the dealcoholization-polycondensation of the alkyl ether of hydroxyalkanoic acid, as described in Volova, “Polyhydroxy Alkanoates Plastic Materials of the 21” Century: Production, Properties, and Application, Nova Science Publishers, Inc., (2004), incorporated herein by reference. The sealant in this aspect of the invention is present in a thickness of about 5 μm to about 100 μm, preferably about 7 μm to about 50 μm, more preferably about 10 μm to about 25 μm. For example, when the package encloses a liquid, the sealant is present in a thickness of about 20 μm to about 50 μm; and when the package encloses a powder, the sealant is present in a thickness of about 15 μm to about 40 μm. The thickness of the sealant, barrier material, substrate, and/or layer in any aspect of the invention can be determined by any method known to one skilled in the art, such as with standard calipers. A thinner sealant results in a package with a faster biodegradation rate. A thicker sealant results in a package with an increased structural integrity, but a slower biodegradation rate. Optionally, the sealant includes a filler in an amount of about 1 vol % to about 30 vol. %, based on the total volume of the sealant. Nonlimiting examples of the filler include graphene, graphene oxide, calcium carbonate, nano clays and waxes.

In order to ensure good adhesion between the sealant and coating layers- and the metal barrier layer anhydride or acid-modified ethylene and propylene homo- and co-polymers can optionally be used as extrudable adhesive layers, as described in US. Patent Application No. 2009/0191371, which is incorporated herein by reference, to improve bonding of the PHA to the metal barrier layer. The exact compositions of the adhesive layers are determined according to the particular compositions of the adjoining layers to be bonded in a multilayer structure. One skilled in the polymer art can select the appropriate adhesive layer based on the other materials used in the structure. Adhesive layer compositions, such as, hot melt adhesives, solvent-based adhesives, and water-based adhesives are suitable.

In the current embodiment the sealant is applied at low enough levels so as not to create a self-supporting layer on its own, but enough to sufficiently seal the Aluminum together. Lamination involves laying down a molten curtain of sealant polymer onto the metal barrier layer moving at high speeds (typically about 100 to about 1000 feet per minute, preferably about 300 to about 800 feet per minute) as they come into contact with a cold (chill) roll. The molten curtain is formed by extruding the sealant polymer through a slot die. Solution-based adhesive compositions may also be used to adhere the film to the substrate. Nonlimiting examples of the adhesive can include acrylic, polyvinyl acetate, and other commonly used adhesive tie layers suitable for polar materials. In some embodiments, the adhesive is a renewable adhesive, such as BioTAK® by Berkshire Labels.

The exact composition and thickness of the metal barrier layer in the first aspect of the invention is determined by the intended use of the package, and the sensitivity of the consumer product within the package to gaining or losing a certain material. For example, if the package encloses a shampoo, a critical amount of water loss from the shampoo will severely impact its performance Based on the projected time that the package is expected to remain in the trade, a desired shelf life or expiration date is defined. With the known acceptable amount of water loss, length of time in the trade, and package size, an acceptable flux of water is then defined. The barrier material composition and barrier thickness is then chosen based on the particular performance criteria and characteristics of each consumer product that is enclosed within the package. The barrier material can also function as a barrier for gases, e.g. nitrogen, carbon dioxide or oxygen, and volatile formulation ingredients, e.g. perfumes, fragrances and flavors.

The barrier material in this aspect of the invention is selected from the group consisting of a metal or metal alloy. The barrier material has a surface energy that is at least about 38 dynes/cm, preferably at least about 42 dynes/cm, or the barrier material can be treated to result in the desired surface energy using techniques known to one skilled in the art, such as corona treatment. The surface energy of the barrier material can be determined by any method known to one skilled in the art. If the surface energy is less than about 38 dynes/cm, the barrier material will not accept printing inks on its surface. The barrier material is present in a thickness of about 7 μm to about 100 μm, preferably about 10 μm to about 50 μm, more preferably about 15 μm to about 30 μm. In one embodiment of this aspect of the invention, the degradable sealant is PHA and the barrier material is metal or metal alloy, as shown in FIG. 1.

In a second aspect, the invention relates to a package represented by FIG. 2. In this aspect, the package includes a layer composed of a biodegradable sealant and a barrier material. Ink is deposited on the metal barrier layer, and the ink is optionally coated with a lacquer or outer polymer film.

The sealant in this aspect of the invention can be any biodegradable polymer. In some embodiments of this aspect of the invention, the sealant is as described in the first aspect of the invention. The barrier material of the layer of this aspect of the invention is a metal or metal alloy, preferably with aluminum as the major constituent.

In all aspects of the invention, the ink that is deposited can be either solvent-based or water-based. In some embodiments, the ink is high abrasive resistant. For example, the high abrasive resistant ink can include coatings cured by ultraviolet radiation (UV) or electron beams (EB). In some embodiments, the ink is derived from a petroleum source. In some embodiments, the ink is derived from a renewable resource, such as soy, a plant, or a mixture thereof. Nonlimiting examples of inks include ECO-SUREI™ from Gans Ink & Supply Co. and the solvent-based VUTEk® and BioVu™ inks from EFI, which are derived completely from renewable resources (e.g., corn). The ink is present in a thickness of about 0.5 μm to about 20 μm, preferably about 1 μm to about 10 μm, more preferably about 2.5 μm to about 3.5 μm. The optional lacquer in all aspects of the invention functions to protect the ink layer from its physical and chemical environment. In some embodiments, the lacquer is selected from the group consisting of resin, additive, and solvent/water. In some preferred embodiments, the lacquer is nitrocellulose-based lacquer. The lacquer is formulated to optimize durability and provide a glossy or matte finish. The lacquer is present in a thickness of up to about 25 μm, preferably up to about 10 μm. The amount of lacquer present affects the rate of degradation for the total package, not the rate of the degradation of the lacquer itself. Thus, a thinner lacquer layer results in a faster biodegradation rate for the total package.

In some embodiments, the biodegradable packages and articles of the invention are substantially free of oxo-biodegradable additives (i.e., less than about 1 wt. %, based on the total weight of the package or article). As previously described herein, oxo-biodegradable additives consist of transition metals that theoretically foster oxidation and chain scission in plastics when exposed to heat, air, light, or a mixture thereof. Although the shortened polymer chains theoretically can be consumed by microorganisms found in the disposal environment and used as a food source, there is no data to support how long these plastic fragments will persist in the soils or marine environments, or if biodegradation of these fragments occurs at all.

In some embodiments, the biodegradable packages and articles of the invention contain a consumer product, such as a liquid or a powder. As used herein, “consumer product” refers to materials that are used for hair care, beauty care, oral care, health care, personal cleansing, and household cleansing, for example. nonlimiting examples of consumer products include shampoo, conditioner, mousse, face soap, hand soap, body soap, liquid soap, bar soap, moisturizer, skin lotion, shave lotion, toothpaste, mouthwash, hair gel, hand sanitizer, laundry detergent, dish detergent, dishwashing machine detergent, cosmetics, and over-the-counter medication. The packages and articles of the invention are resistant to the consumer product. As used herein, “resistant” refers to the ability of the packages and articles to maintain their mechanical properties and artwork on their surfaces, as designed, without degradation from consumer product interaction and diffusion of the consumer product through the package material.

### Method of Making

The films used to produce the packages and articles of the invention can be processed using conventional procedures for producing multilayer films on conventional coextruded film making equipment. See, e.g., U.S. Pat. Nos. 5,391,423 and 5,939,467, which are each incorporated herein by reference. In general, polymers can be processed into films using either cast or blown film extrusion methods. See, e.g., Griff, “Plastics Extrusion Technology,” 2″ Ed., Van Nostrand Reinhold, 1976, which is incorporated herein by reference. Cast film is extruded through a linear slot die. Generally, the flat web is cooled on a large, moving polished metal roll. The film peels off this first roll, passes over one or more auxiliary cooling rolls, through a set of rubber-coated pull or “haul-off” rolls, and then to a winder. In blown film extrusion, the melt is extruded upward through a thin annular die opening, a process referred to as tubular film extrusion. Air is introduced through the center of the die to inflate the tube, which causes it to expand. A moving bubble results, which is maintained at a constant size by controlling the internal air pressure. The tube of the film is cooled by blowing air through one or more chill rings surrounding the tube. The tube is then collapsed by drawing it into a fattening frame through a pair of pull rolls and into a winder.

Both cast film and blown film processes can be used to produce either monolayer or multilayer film structures. The production of monolayer films from a single thermoplastic material or blend of thermoplastic components requires only a single extruder and single manifold die. If a particular film requires a blend (e.g., sealant/barrier material, sealant/filler), pellets of the components first can be dry blended and then melt mixed in the extruder feeding that layer. Alternatively, if insufficient mixing occurs in the extruder, the pellets can be first dry blended and then melt mixed in a pre-compounding extruder, followed by repelletization prior to film extrusion. Coextrusion processes are employed for the production of multilayer films. Such processes require more than one extruder and either a coextrusion feedblock or multi-manifold die system, or combination of the two, to achieve the multilayer film structure. The feedblock principle of coextrusion is described in U.S. Pat. Nos. 4,152,387, and 4,197,069, each incorporated herein by reference. Multiple extruders are connected to the feedblock, which employs moveable flow dividers to proportionally change the geometry of each individual flow channel in direct relation to the volume of polymer passing through the flow channels. The flow channels are designed such that the materials flow together at the same flow rate and pressure at their point of confluence, eliminating interfacial stress and flow instabilities. After the materials are joined in the feedblock, they flow into a single manifold die as a composite structure. The melt viscosities and melt temperatures of the materials should not differ too greatly; otherwise flow instabilities can result in the die leading to poor control of layer thickness distribution in the multilayer film, as described in U.S. Pat. No. 5,498,692.

An alternative to feedblock coextrusion is a multi-manifold or vane die as disclosed in aforementioned U.S. Pat. Nos. 4,152,387, 4,197,069, and in U.S. Pat. No. 4,533,300, incorporated herein by reference. Whereas in the feedblock system melt streams are brought together outside and prior to entering the die body, in a multi-manifold or vane die each meltstream has its own manifold in the die where the polymers spread independently in their respective manifolds. The melt streams are married near the die exit, with each melt stream at full die width. Moveable vanes provide adjustability of the exit of each flow channel in direct proportion to the volume of material flowing through it, allowing the melts to flow together at the same linear flow rate, pressure, and desired width. Because the melt flow properties and melt temperatures of the processed materials may vary widely, use of a vane die has several advantages. The die lends itself toward thermal isolation characteristics wherein materials of greatly differing melt temperatures, for example up to 80° C., can be processed together. Each manifold in a vane die can be designed and tailored to a specific polymer. This allows materials with greatly differing melt viscosities to be coextruded into multilayer films. In addition, the vane die also provides the ability to tailor the width of individual manifolds, such that an internal layer, can be completely surrounded by water insoluble materials leaving no exposed edges susceptible to water. The aforementioned patents also disclose the combined use of feedblock systems and vane dies to achieve more complex multilayer structures.

Polymeric films formed by any of the aforementioned processes can be combined with a metal or metal alloy barrier layer by heated lamination of a pre-formed film or direct extrusion of the film onto the metal barrier layer. Optionally the metal layer can be pre-treated by corona treatment or by coating with a tie layer to improve adhesion of the biodegradable polymer sealant layer.

Polymeric film coatings on metal or metal alloy barrier layers can also be created by coating a solution or dispersion of the biodegradable polymer onto the metal and drying in an oven to remove the carrier solvent or water and leave a polymeric film. Optionally the metal layer can be pre-treated before coating by corona treatment or by coating with a tie layer to improve adhesion of the biodegradable polymer sealant layer

The polymer—metal composite films that are produced by the aforementioned processes can be converted into the packages and articles of the invention using a form-fill-seal process. A traditional process typically involves three successive steps where the package or article is formed from the film structure, filled, and then sealed or closed, as described in U.S. Pat. No. 6,293,402, which is incorporated herein by reference. In heat sealing methods, a temperature range exists above which the seal would be burnt, and below which the seal would not be sufficiently strong.

Seals are provided by any sealing means known to one skilled in the art. Sealing can comprise the application of a continuously heated element to the film, and then removing the element after sealing. The heating element can be a hot bar that includes jaws or heated wheels that rotate. Different seal types include fin seals and overlap seals. Single Lane Process a well-known sealing single lane process using a vertical form and fill machine is described in U.S. Pat. No. 4,521,437, incorporated herein by reference. In this process, a flat web of synthetic thermoplastic film is unwound from a roll and formed into a continuous tube by sealing the longitudinal edges on the film together to form a lap seal (i.e., fin seal). The resulting tube is pulled vertically downwards to a filling station, and collapsed across a transverse cross-section of the tube, the position of such cross-section being at a sealing device below the filling station. A transverse heat seal is made by the sealing device at the collapsed portion of the tube, thus making an air tight seal across the tube. After making the transverse seal, a pre-set volume of material to be packaged, e.g. flowable material, enters the tube at the filling station, and fills the tube upwardly from the aforementioned transverse seal. The tube is then dropped a predetermined distance under the influence of the weight of the material in the tube, and of the film advance mechanism on the machine. The jaws of the sealing device are closed, collapsing the tube at a second transverse section, which is above the air/material interface in the tube. The sealing device seals and severs the tube transversely at said second transverse section. The material-filled portion of the tube is now in the form of a pillow shaped sachet. Thus, the sealing device has sealed the top of the filled sachet, sealed the bottom of the next-to-be-formed sachet, and separated the filled sachet from the next-to-be-formed sachet, all in one operation.

### Multilane Process

The packages of the invention can also be processed using a multilane sachet packaging machine, such as the VEGA PACK 300S by QuadroPack. A high-speed, multi-lane sachet processing machine is also described in U.S. Pat. No. 6,966,166, incorporated herein by reference. The machine used in this process includes two rolls for dispensing sheets of webbed film of equal dimensions, a plurality of sealing devices appropriate for such film, and means, such as the pump station described below for inserting contents (e.g., liquid, viscous materials, other substances) into the film packages. A plurality of packages can be produced by utilizing one or more moveable reciprocating carriages that travel with the flow of film through the machine, the carriages supporting each of the sealing and cross cutting stations. The sealing devices are applied to all but one of the edges, forming a pouch with a cavity and an opening. The desired contents of the package are inserted into the cavity through the opening. The opening is then sealed and separated from the film. A pair of film rolls is provided at the film roll station. Alternatively, a cutter can be placed at a middle of a single nip roller to divide the film width into two equal parts. Sheets of film are advanced through the apparatus by the pull-wheel station and used to form the front and back panels of the package. The film from each roll is guided so that the two sheets of film are in close proximity to, and in a parallel relationship with, one another when they are advanced through the machine.

The sealing and cutting devices include: longitudinal sealing bars to seal the package's vertical sides, a unidirectional roller to hold the film in position and prevent it from sliding backward, a vertical cutter to cut a tear-off slit into the package in the vertical direction, and cross sealing bars to seal the packages in horizontal direction. The pump station comprises of a plurality of fill dispensers in communication with a storage structure containing the consumer product into the package. These dispensers are capable of drawing a pre-determined quantity of consumer product from a reservoir and depositing it into the cavities of the film packages formed by the machine. In the preferred embodiment, the pump station and dispensers may be driven by one or more motion-controlled servomotors in communication with the cam system. The quantity of consumer product may be changed by exchanging the dispensers (with different dispensers having more or less capacity), changing the stroke of the pump cycle, changing the timing of the pump cycle, and the like. Therefore, different quantities of consumer products can be dispensed, depending upon the size and capacity of the packages to be formed by the machine.

A preferred embodiment of this invention is an aluminum foil barrier layer with a PHA sealant layer, which is adhesively laminated to a reverse printed PHA outer layer. This sachet may be used to contain liquid or solid products.

In another embodiment an aluminum foil barrier layer with a PVOH sealant layer is adhesively laminated to a reverse printed PHA outer layer. This sachet may be used to contain solid products.

In another embodiment an aluminum foil barrier layer with a PVOH sealant layer is adhesively laminated to a reverse printed PBS outer layer. This sachet may be used to contain solid products.

In another embodiment an aluminum foil barrier layer with a PBS sealant layer is adhesively laminated to a reverse printed PBS outer layer. This sachet may contain liquid or solid products.

In another embodiment an aluminum foil barrier layer with a PBS sealant layer is adhesively laminated to a reverse printed PHA outer layer. This sachet may contain liquid or solid products.

In another embodiment an aluminum foil barrier layer with a PHA sealant layer is adhesively laminated to a reverse printed PBS outer layer. This sachet may contain liquid or solid products. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A package comprising:
(a) a biodegradable sealant having a thickness of about 5 μm to about 100 μm;
(b) a barrier material selected from the group consisting of a metal or metal alloy coated with the sealant, wherein the barrier material has a thickness of about 7 um to about 100 μm and a surface that has an energy of at least about 38 dynes per centimeter (dyne/cm), or that is treatable to an energy of at least about 38 dyne/cm; and,
(c) biodegradable ink deposited on the barrier material, and having a thickness of about 0.5 μm to about 20 μm;
(d) a biodegradable protective layer on the outside of the package having a thickness of about Sum to 25 μm;
wherein the package has a moisture vapor transmission rate (MVTR) of less than about 10 grams per square meter per day (g/m2/day) at 37° C. and 90% relative humidity (RH);
wherein the package has a shelf life of at least about one year when containing a liquid consumer product;
wherein the sealant layer of the package, within two years after first and continuous exposure to water and sealant-degrading microorganisms, disintegrates into pieces sufficiently small to pass through a one millimeter sieve, and,
wherein the package, if collected, can be recycled using existing aluminum recycling streams.

2. The package of claim 1, wherein the biodegradable sealant and biodegradable protective layer is selected from the group consisting of polyhydroxy alkanoate (PHA), polyvinyl alcohol, aliphatic aromatic polyesters, thermoplastic starch, polybutylene succinate, copolymers of polybutylene succinate, starch-based film, and mixtures thereof.

3. The package of claim 1, wherein the biodegradable sealant and biodegradable protective layer is selected from the group consisting of PHA and PHA blends.

4. The package of claim 1, wherein the package has a shelf life of at least about two years.

5. The package of claim 1, wherein the biodegradable layers of the package disintegrate into pieces sufficiently small to pass through a one millimeter sieve, within 18 months after first and continuous exposure to water and sealant-degrading microorganisms.

6. The package of claim 1, wherein the ink is selected from the group consisting of petroleum-based ink, soy-based ink, plant-based ink, or mixtures thereof.

7. The package of claim 1, wherein the package comprises less than about 1 wt. % of an oxo-biodegradable additive.

8. The package of claim 1, wherein the sealant further comprises a filler in an amount of about 1 vol. % to about 30 vol. %, based on the total volume of the sealant.

9. The package of claim 8, wherein the filler is selected from the group consisting of nanoclay, graphene, graphene oxide, calcium carbonate, wax, and mixtures thereof.

10. The package of claim 1 further comprising a lacquer or film coating the ink and having a thickness of up to about 25 μm.

11. The package of claim 10, wherein the lacquer is selected from the group consisting of resin, additive, solvent/water, and mixtures thereof.

12. The package of claim 1, wherein the package encloses a consumer product and is resistant to the consumer product.

13. The package of claim 12, wherein the consumer product is a liquid and the package has a MVTR of less than about 2 g/m2/day.

14. The package of claim 12, wherein the consumer product is a powder and the package has a MVTR of less than about 5 g/m2/day.

15. A package comprising:
(a) a layer comprising a mixture of:
(i) a biodegradable sealant, and
(ii) a barrier material selected from the group consisting of metal or metal alloy,
wherein the layer has a thickness of about 5 μm to about 100 μm, and a surface that has an energy of at least about 38 (dyne/cm), or that is treatable to an energy of at least about 38 dyne/cm; and,
(b) ink deposited on the layer, and having a thickness of about 1 μm to about 20 μm;
wherein the package has a moisture vapor transmission rate (MVTR) of less than about 10 g/m2/day at 37 C, and 90% RH; and
wherein the package has a shelf life of at least about one year when containing a liquid consumer product; and, wherein the biodegradable layers of the package, within two years after first and continuous exposure to water and sealant-degrading microorganisms, disintegrates into pieces sufficiently small to pass through a one millimeter sieve.
